(19) United States
(12) Patent Application Publication
(10) Pub. No.: US 2019/0095933 A1
(43) Pub. Date: Mar. 28, 2019

(54) WIRELESS RETAIL STORE BEHAVIOR AND TRACKING ANALYSIS SYSTEM

(71) Applicant: Kevin Vincent Doherty, New York, NY (US)

(72) Inventor: Kevin Vincent Doherty, New York, NY (US)

(21) Appl. No.: 15/934,149

(22) Filed: Mar. 23, 2018

Related U.S. Application Data
(60) Provisional application No. 62/475,453, filed on Mar. 23, 2017.

(51) Int. Cl. G06Q 30/02; H04W 4/029

(52) U.S. Cl. CPC G06Q 30/0201; G06Q 30/0239; H04W 4/029

(57) ABSTRACT

A shopping analysis system captures, saves, and displays a number of variables related to a shopper's experience, including time spent shopping, path traveled within the store by shopper, specific areas visited within the store, time spent in a particular area of the store, total time spent in the store, items removed from shelves, items placed in cart and or basket or other carrying device, items put back on the shelves, items purchased. In embodiments, one or more wireless communication devices may be associated with shopping equipment to provide shopper data.

### PRIORITY CLAIM

This application claims priority to U.S. Patent Application No. 62/475,453 filed Mar. 23, 2017 and titled, “WIRELESS RETAIL STORE BEHAVIOR AND TRACKING ANALYSIS SYSTEM,” the contents of which is incorporated by reference in its entirety.

### BRIEF DESCRIPTION OF THE DRAWINGS

The features and advantages of the present disclosure will be more fully understood with reference to the following detailed description when taken in conjunction with the accompanying figures, wherein:

FIG. 1 illustrates an embodiment of the system in which a wireless communication device is placed on a store's exterior and another wireless communication device is placed near the retailer's exterior.

FIG. 2 illustrates an embodiment of the system in which wireless communication devices are distributed within a retail environment.

FIGS. 3-4 illustrate embodiments of the system in which a wireless communication device is associated with a piece of shopping equipment.

FIG. 5 illustrates an embodiment of the system in which a wireless communication device is configured to receive data from multiple sources.

### BACKGROUND AND DETAILED DESCRIPTION

Individuals shopping at retailers often utilize shopping equipment like carts and baskets, often provided by the retailer. These devices are often simplistic and utilize technology dating back 50 years or more. The retailer is unable to learn about a shopper's habits and preferences other than through the final goods purchased.

In these traditional systems, there is no means to capture, save, or display, via a user interface, a number of variables, including time spent shopping, path traveled within the store by the shopper, specific areas visited within the store, time spent in a particular area of the store, total time spent in the store, items removed from shelves, items placed in cart and or basket or other carrying device, items put back on the shelves, or items purchased.

A system and method are disclosed for tracking a shopper as the shopper moves through a retail store environment. Utilizing wireless communication with wireless devices in, near, or attached to a store or a specific area within a store, or a piece(s) of shopping equipment (including but not limited to carts, baskets, etc.), a shopper's actions or shopping behaviors or movements or experiences or shopping trip, etc. are communicated wirelessly to a store's wireless device or at least a subset of this information may be saved in the shopping analysis system or in a database or in memory which may run on a store's wireless communication device. At least a subset of this information, or the information contained in the shopping analysis system, may be saved in-memory or in a database.

In one such method, wireless communication between a wireless device or the store's wireless device is established or a wireless communication is sent between a wireless device and a store's wireless device (cellular phone, MP3 player, personal digital device (PDA), etc.) and, via wireless communication with the aforementioned wireless device, it is determined that an individual, along with at least one piece of shopping equipment, may have entered a store or entered a specific area of a store (produce, banana display, dairy department, bread aisle, standing in front of a particular brand of grocery item) or is standing in a specific spot within the store or is currently utilizing a specific piece of shopping equipment (including but not limited to carts, baskets, etc.).

In this method, a wireless communication device may be placed on, near, or inside a piece of shopping equipment (including but not limited to carts, baskets, etc.) or a specific area within the store or a store and wireless communication may be established between the store's wireless device or any/all of these wireless devices. In this method, communication between the store's wireless device or the store or the specific area of the store or the specific piece of shopping equipment, would be established, which may make the store's wireless device aware of where the user may be located relative to the store or an area within the store or a specific area within the store (near a specific item). This information may inform the system as to where in the store or what specific area of the store the customer is shopping in at a given point in time.

The shopping analysis system may receive wireless communications from the wireless device(s) placed near, on, or inside the shopping equipment, or the wireless device placed within or near the store or the wireless devices placed within or near specific areas within the store. The information sent to the shopping analysis system from these wireless devices may provide insight into the user's shopping trip or purchases or this information may be used to facilitate recommended purchases during this trip or subsequent shopping trips. The shopping analysis system, which may be aware of the users' shopping goals, or shopping preferences, may continuously receive wireless communications from the shopping equipment, or the store or the specific area of the store and this information may be used to update information in the shopping analysis system or the user interface on the store's wireless device or the information contained in the database or the information contained in-memory. These updates to the shopping analysis system can take place prior to, during, or after the user has entered the store or the specific area within the store or has engaged with an area(s), or items for sale in the store or the user has completed their shopping trip.

The information received by the store's wireless device from these wireless devices over the course of the user's shopping trip (items engaged with, items purchased, areas traveled to, time spent in the store, time spent in a given area, etc.) may be utilized to facilitate subsequent shopping trips prior to, during, or after a shopping trip has been completed. In another method, when the user leaves an area or based on a schedule, the shopping analysis system may be updated.

When the user leaves the store or moves beyond a certain proximity from a wireless communication device, the shopping analysis system may receive a wireless communication notifying the system that the user has left the facility or moved beyond a certain distance from an area or the shopping trip may be concluded or the appropriate actions in the shopping analysis system may be triggered via wireless communication.

The store owner, and in certain instances the customer(s), has the ability to view at least a subset of their, or the other users' information in the shopping analysis system and the store owner or the customer may have the ability to share their personal information (credit card, purchases made, etc.) or their shopping trip information with other users or third-parties. This information may be viewed or shared prior to, during, or after the shopping trip has completed. The user may also choose to share their personal statistics or their shopping trip information with third parties.

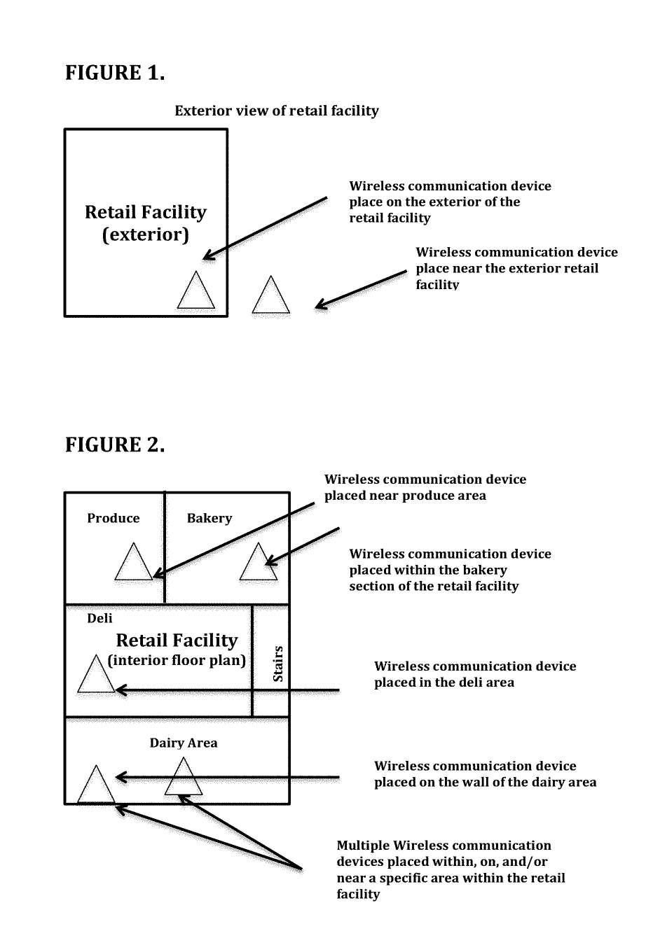

FIG. 1 shows an embodiment of the system wherein a wireless communication device is placed on a store's exterior and another wireless communication device is placed near the retailer's exterior. In this embodiment, the store's wireless communication device would receive a wireless communication when a piece of shopping equipment enters a given proximity surrounding any or multiple or all wireless communication devices. Entering this proximity may trigger the shopping analysis system to take an action or update the database or update the information in memory or update the user interface.

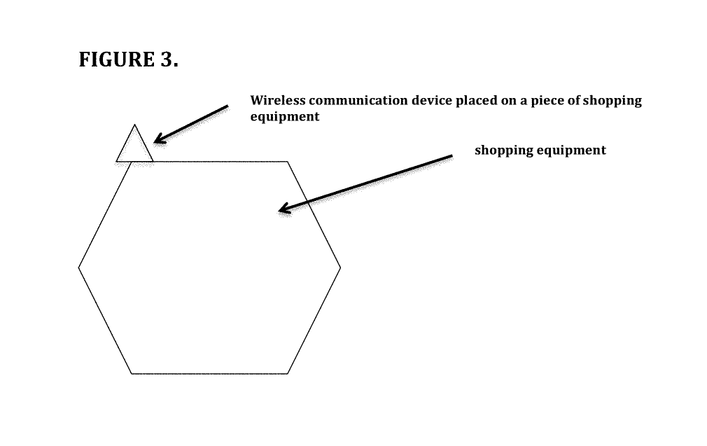

FIG. 2 is one embodiment which could be separate or in addition to the embodiment in FIG. 1. The embodiment displayed in FIG. 2 includes wireless communication devices placed in various areas within the store (the deli, the bakery, etc.). In this embodiment, the store's wireless communication device would receive a wireless communication when a piece of shopping equipment enters a given proximity surrounding any or multiple or all wireless communication devices. Entering this proximity may trigger the shopping analysis system to take an action or update the database or update the information in memory or update the user interface.

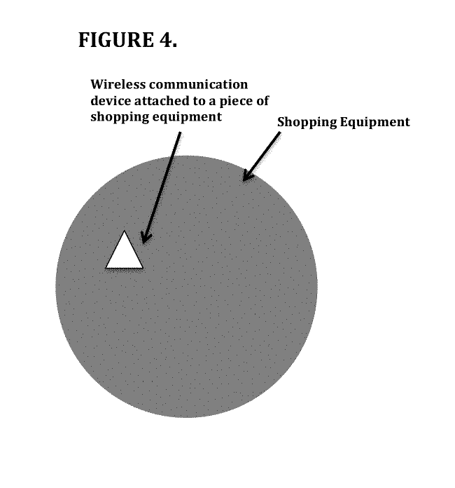

FIG. 3 is one embodiment which could be separate or in addition to the embodiment in FIG. 1 or the embodiment in FIG. 2. The embodiment displayed in FIG. 3 includes a wireless communication device placed on a piece of shopping equipment (including but not limited to carts, baskets, etc.). In this embodiment, the store's wireless communication device would receive a wireless communication when a piece of shopping equipment enters a given proximity surrounding the wireless communication device. The system may also receive information regarding the movement of the shopping equipment, or portion of the shopping equipment, should the wireless communication device also contain and accelerometer or altimeter or magnetometer. Entering this proximity may trigger the shopping analysis system to take an action or update the database or update the information in memory or update the user interface.

FIG. 4 is one embodiment which could be separate or in addition to the embodiment in FIG. 1 or the embodiment in FIG. 2 or the embodiment in FIG. 3. The embodiment displayed in FIG. 4 includes a wireless communication device placed on a piece of shopping equipment. In this embodiment, the store's wireless communication device would receive a wireless communication when the shopping equipment enters a given proximity surrounding the wireless communication device. The system may also receive information regarding the movement of the shopping equipment should the wireless communication device also contain and accelerometer or altimeter. Entering this proximity may trigger the shopping analysis system to take an action or update the database or update the information in memory or update the user interface.

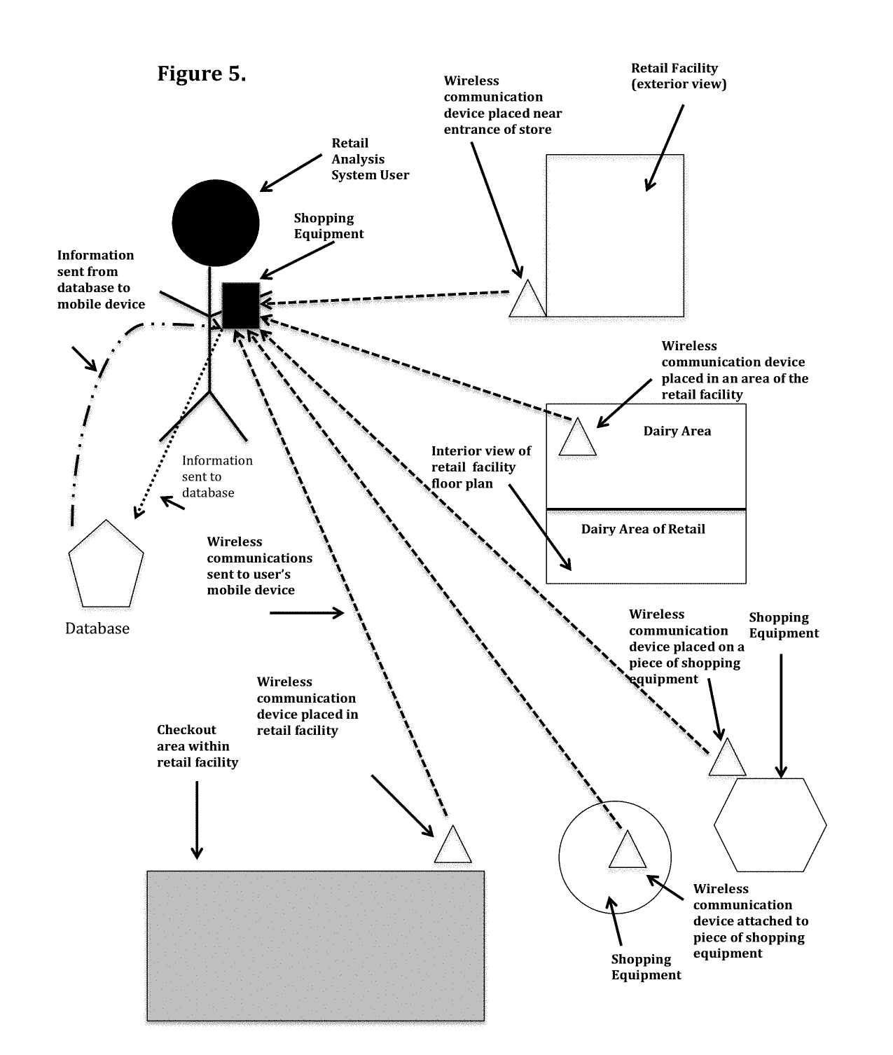

FIG. 5 is one embodiment which could be separate or in addition to the embodiment in FIG. 1 or the embodiment in FIG. 2 or the embodiment in FIG. 3 or the embodiment in FIG. 4. This embodiment shows a user with a wireless communication device receiving information from five different sources—a wireless communication device located near the retailer's exterior, a wireless communication device placed within a certain area of the store, a wireless communication device placed on a piece of shopping equipment (including but not limited to carts, baskets, etc.), and a wireless communication device placed near the retailer's checkout area.

In this embodiment, the store's wireless communication device would receive a wireless communication when a piece of shopping equipment enters a given proximity surrounding a single wireless communication device or multiple wireless communication devices or all of the wireless communication devices. The system may also receive information regarding the movement of the shopping equipment, or a portion of the shopping equipment. Entering any or some or all of the proximities may trigger the shopping analysis system to take an action or update the database or update the information in memory or update the user interface.

In view of the limitations outlined, methods, and wireless devices for use in connection with a shopping trip and shopping equipment, is disclosed herein. The subject matter of the disclosed embodiments is described with specificity to meet statutory requirements. The embodiments disclosed herein allow a person to use a wireless device in connection with a shopping trip or shopping equipment (including but not limited to carts, baskets, etc.).

In one embodiment, a wireless communication may be sent from a piece of shopping equipment to a wireless communication device located inside, near, or attached to a store or within a specific area of the store or an area(s) when that user has entered or exited a store or a specific area of the store (produce department, banana display, bakery, deli, area displaying energy drinks, coffee department, etc.) or utilized a piece of shopping equipment (including but not limited to carts, baskets, etc.). The wireless communication devices may have installed within their housing, or have available to them, an accelerometer or a magnetometer or an altimeter or a thermometer. This wireless communication may include information including, but not limited to the user's location from a given wireless communication device, the shopping equipment (including but not limited to carts, baskets, etc.)'s name, the shopping equipment (including but not limited to carts, baskets, etc.)'s description, the speed at which the user or the shopping equipment, is traveling, the time the wireless communication was sent, the battery level of the wireless communication device, the radius being monitored, and the height of the wireless communication device.

A method may recognize that a user or the store's wireless communication device has entered or exited a store or a specific area of the store or is utilizing an area, or utilizing a piece(s) of shopping equipment, when that user or the store's wireless device comes within a certain proximity (distance may vary on a case by case matter) of a wireless communication device(s) located within or near or attached to that store or a specific area within the store or a piece of shopping equipment (including but not limited to carts, baskets, etc.). This communication may update the store's wireless device or the shopping analysis system or the user interface or the retailers existing hardware or software as to the user's location within the store or within a specific area within the store. The shopping equipment (including but not limited to carts, baskets, etc.), via a wireless communication device attached to or near or inside the shopping equipment (including but not limited to carts, baskets, etc.), may notify the store's wireless device or the shopping analysis system or the user interface or the retailers software or hardware, via a wireless communication, as to which piece(s) of shopping equipment, a user may currently be utilizing or what areas of a store a user has visited or what items within a store a user has engaged with or has previously visited or intends to engage with subsequently (a method may determine the proximity of a store or a specific area within a store or area of the store that a customer may want to or may mostly likely travel to next) to the store's wireless device—this method is not the only manner or method in which a user's location or actions or shopping trip can be calculated and other methods may be applicable). One method may determine that a user has entered or exited a store based on the user's distance, as measured by their wireless device, from a wireless communication device placed on, near or within the store or a specific area within the store or a specific piece of shopping equipment (this method is not the only manner or method in which distance or exit/entry can be calculated). Each store or specific area within a store or piece of shopping equipment, may receive its own unique identifier and based on the unique identifier of facility or the specific area within the facility or the area, or the shopping equipment, (multiple pieces of shopping equipment may each receive their own unique identifier), a method may determine where in the facility the user may be or what specific equipment the user is utilizing or determine, via a method, additional information regarding the users shopping trip including areas visited or items engaged with or items purchased (this method is not the only method in which a user's location or a user's shopping trip or actions can be determined and other methods may be applicable). The method may also be able to determine the name of the previously visited or currently visiting or areas to be visited in the future or the duration of the visit or shopping trip (the duration of the visit to that specific area, the duration of the visit to the store in total, the items engaged with, the items purchased, etc.). Additional information regarding the user or the user's shopping trip which may be collected by the system or stored in the database or used to update the interface, include, but are not limited to, the path taken during the shopping trip, the time spent interacting with a specific product, the time spent in a given location in the store, the area likely to be visited next, the purchases made, the purchases likely to be made this trip or the next trip. This information may be updated at certain time intervals throughout the user's shopping trip or as the user progresses with their shopping trip or with each different action a user completes while completing the shopping trip. These updates may continue until the wireless device or the shopping analysis system receive a wireless message from a wireless communication device within the store that may notify the store's wireless device or the shopping analysis system that the user has left the store or that specific area of the store or has moved away from an areas(s), or has moved beyond a certain distance from the store or has moved beyond a certain distance from a specific area(s) of the store or has paid and checked out or has entered the parking lot and is ready to leave. The shopping analysis system may also be updated as the user moves within the store or utilizes different areas of the store or utilizes different areas of shopping equipment (including but not limited to carts, baskets, etc.). Based on the proximity of the store's wireless communication device to wireless communication devices placed on, near or within the store or a specific area within the store or specific areas of shopping equipment (including but not limited to carts, baskets, etc.), we may be able to determine, via a method, what shopping behaviors or shopping trips a user is completing. At least a subset of this shopping behavior information may be stored in-memory or in a database or on the retailers existing software or may be available to the user or store owner before or during or after their shopping trip or may be utilized for planning future shopping trips or updating store layouts or floorplans or structuring pricing or sales or other business uses. The store owner may also use their wireless device, including, mobile phone, a personal computer, tablet, etc., to access other information on the system (merchandising recommendations, promotional recommendations, customer traffic forecasts, etc.) or use the information before, during, or after the shopping trip. The shopping behavior information may include, but is not limited to, users' shopping trip data, shopping trip path information, customer count. The user may also input information (items purchased, items considered for purchase, items not considered for purchase, etc.) into the shopping analysis system or review shopping information (suggested items for purchase, etc.) in shopping analysis system before or during or after their shopping trip. In certain circumstances, information may also be visible by, or shareable with other users of the shopping analysis system, including other users of the shopping analysis system or store personnel or store owners or store management. The user may also choose to share their personal statistics or their shopping trip information with third parties.

In another embodiment, wireless communication devices are attached to, near, or within a store and the store's wireless device may be notified of the user's entry into or exit from the store or their entry into or the exit from a specific area within the store. The store's wireless device may continue to receive updates (via wireless communication) as the user moves through the store before, during, or after their shopping trip. Once the user has moved out of a specific area or moved away from a specific piece of shopping equipment, or has left the store entirely, the shopping analysis system or the store's wireless device may receive a wireless communication, from a wireless communication device within the store or within a specific area of the store or a wireless communication device attached to, located near, or inside a specific area, or multiple areas or attached to shopping equipment (including but not limited to carts, baskets, etc.), notifying the system, or the store's wireless device or the store's existing hardware or software, of the change in user's location. At least a subset of this information would be used to update the interface or may be captured in the store's wireless device(s)'s memory or in a database. At least a subset of this information may be stored in-memory or in the database or in the store's existing software or hardware and may be available to the user before, during, or after their shopping trip or may be utilized for planning future shopping trips. These updates may continue until the wireless device or the shopping analysis system receives a wireless message from a wireless communication device within or near or attached to the store or a specific area of the store or attached to the shopping equipment notifying the store's wireless device or the shopping analysis system that the user has left the store or a specific area of the store entirely. The user may also use their wireless device, including but not limited to a mobile phone, personal computer, tablet, smartwatch, etc., to access shopping information associated with their, or other user's, shopping trips or use the information before or during or after the shopping trip. This information may be available to the user via a user interface on their wireless communication device, including, mobile phone, tablet, personal computer, another store's wireless device, etc. The shopping information can include, but is not limited to, other users' shopping trips or shopping trip suggestions or forum information or discussions. The user may also input information (purchases, items engaged with, items not engaged with, etc.) into the shopping analysis system or review shopping trip information in shopping analysis system before, during, or after the shopping trips. In certain circumstances information may also be visible by, or shareable with, other users of the shopping analysis system, including other users of the shopping analysis system or store center personnel or store management. The user may also choose to share their personal statistics or their shopping trip information or payment information with third parties.

In one embodiment, the system may be implemented and utilized in the following manner. The user may have a shopping analysis system in the form of a mobile device application that is saved or downloaded to their wireless communication device, or a web application accessible via the Internet. The store's wireless communication device may have access to Bluetooth or Bluetooth low energy capabilities. This wireless device includes a memory store that stores a portion or all of the shopping trip information related to a user's shopping trip, personal statistics, other user's information (this represents a portion of the information that could be captured and is not intended to limit the scope in any way). The information saved on this device includes, but is not limited to, the unique identifier information associated with the specific area of the store. Information that can also be saved in this device's memory includes, but is not limited to, shopping trip duration (how long the user was in a specific area of the store for, time spent in a given area, time spent in the store in total, etc.) or items purchased. This wireless device includes a user interface module that permits user interaction with the wireless device. The store may have Bluetooth or Bluetooth low energy wireless communication devices installed in various areas within their facility or attached to, placed near, or placed inside shopping equipment (including but not limited to carts, baskets, etc.). These wireless communication devices and the shopping analysis system may work independently or in conjunction with the software or hardware that the store currently utilizes or may utilize in the future. The wireless communication devices placed in, within, or near the store contain at least one identifier that may be unique to each wireless communication device or a group of wireless communication devices. The shopping analysis systems understands a user is utilizing a store or a specific area within a store or a specific area, or multiple areas of the store or is engaging with an item or is going to purchase an item or is utilizing pieces of shopping equipment, based on a wireless signal sent to the shopping analysis system from a wireless device located on, near, or within a store or a specific area within the store or a piece of shopping equipment (including but not limited to carts, baskets, etc.). The system may understand which store or area of a store or areas of a store a user is utilizing based on their proximity to a wireless communication device. Once a user has moved beyond the bounds or proximity of a wireless communication device on, near, or within a store or a specific area within a store or on or near or attached to shopping equipment (including but not limited to carts, baskets, etc.), the system may understand that the user is currently not utilizing this store or specific area within a store or a certain piece of shopping equipment, and the shopping analysis system or the database or the memory or the retailers existing hardware or software or the user interface may be updated. The bounds associated with the wireless devices utilized may vary. The shopping analysis system may be updated as deemed necessary. The user or the store personnel or the store management may also use their wireless device, including but not limited to a mobile phone, personal computer, smartwatch, tablet, etc., to access shopping information or use the information before, during, or after the shopping trips. The shopping behavior information can include, but is not limited to, other user's shopping trips, shopping trip suggestions, or forum information or discussions. At least a subset of this shopping information may be stored in-memory or in the database or with the store's existing software or hardware and may be available to the user before, during, or after their shopping trip or may be utilized for planning future shopping trips. The user or the store personnel or the store management may also input information (purchases, length of trip, dwell time, etc.) into the shopping analysis system or review shopping information (purchases, length of trip, dwell time, etc.) in the shopping analysis system before, during, or after the shopping trips. In certain circumstances, information may also be visible by, or shareable with, other users of the shopping analysis system, including other users of the shopping analysis system or shopping center personnel. The user may also choose to share their personal statistics or their shopping trip information with third parties.

In the foregoing discussion, details relating to wireless devices and networks are assumed to be known to those skilled in the art. Accordingly, such details are largely omitted herein for the sake of clarity and explanation. In addition, any references herein to an example embodiment involving a cellular telephone is solely for purposes of explanation and is not intended to limit the invention to any such embodiment. For example, a wireless device as contemplated by various embodiments of the invention may include, but are not limited to: cellular telephones, personal digital assistants (PDA's), MP3 players, email devices, smartwatches, tablets, and the like. The wireless device may operate in a cellular, SMR, PCS, cordless, unlicensed AWS, 700 MHz, or other spectrums. Furthermore, embodiments are not limited by the network servicing the device. Accordingly, embodiments may be applicable to any network type including, for example, TDMA, CDMA, EV-DO, HSDPA/HSUPA, WCDMA, GSM, Wi-Fi, WiMax, OFDM, UMTS, Bluetooth, Bluetooth Low Energy, and other standards now known or to be developed in the future.

### Example 1

In one example, Bluetooth sensors may be embedded within or attached to baskets and or carts in a retail environment. Devices may be positioned to receive signals from the sensors and may include, for example, portable computing devices such as iPads, iPhones, and Android devices, or single-board computers such as the Raspberry Pi. These small computers may be placed in an area of a retail store, in several areas of a store, or throughout an entire store. The computers would receive a bit of data from the wireless sensors every few seconds or milliseconds. The information could include, but is not limited to information regarding the type of shopping equipment the sensor is associated with (shopping basket, shopping cart, etc.), the sensor signal strength, the direction the sensor is moving in, the battery power, and the shopping equipment identifying information. The computing devices could receive signals from the sensors from as far away as a dozen feet. The system could determine where a piece of shopping equipment is, how long it is in area for, all the locations the equipment has been and is expected to go.

### Example 2

In an alternate embodiment, Bluetooth sensors may be embedded or attached to name tags, badges, or pieces of equipment or machinery. Small computers would receive the signals from the wireless sensors. The small computers could include iPads, iPod Touches Raspberry Pi's, or other small computer systems. These computers would be placed in an area including but not limited to a hospital, convention center, retail store, warehouse, office building, roadway, school, fitness center, a city, etc. One computer could be placed in an area, several could be placed in an area, or multiple could be placed throughout an entire building or across an entire area. The computers would receive a bit of data from the wireless sensors every few seconds or milliseconds. The information received could include but is not limited to information regarding what the sensor is attached to (person, equipment, or machinery), and could also include more detailed information (person's name, equipment model number, etc.). Also included in the sensor data could be information regarding the sensor location, sensor signal strength, the direction the sensor is moving in, the speed at which the sensor is moving, sensor motion data, gyroscopic information, magnetometer information, and the battery power of the sensor. The computing devices could receive signals from the sensors from as far away as a several dozen feet. The system could determine where a person or a piece of equipment is, how long it is in area for, all the locations the person/equipment/machinery has been, currently is in, and is expected to go. You could also tell when a person/piece of machinery/equipment enters or exits a specific area (leaves the building, leaves a given proximity around the building, etc.).

### Example 3

In an alternate embodiment, facility owners such as company owners, company management, retail store management, hospital management, grocery store management, convenience store management, restaurant management, or airport management could receive feedback from customers with just one tablet computer stationed and or attached to and or displayed at a register area or area within the store. Customers can answer one question presented on the tablet screen by selecting one of three possible answers/options on the screen. The possible answers/options could also be just “yes” or “no”. Possible question and answer combinations could include a poll-style format. The system would be updated once the user has selected an answer.

### Example 4

In one embodiment, facility owners may receive feedback from customers with a single tablet computer stationed at the front-end register(s) or a section within the facility. Exemplary facility owners may include store owners, company owners, company management, retail store management, hospital management, grocery store management, convenience store management, restaurant management, and airport management, among others. Customers may be enabled to answer one question presented on the tablet screen by selecting one of the possible answers/options on the screen. In embodiments, the answers could also be based on a numerical scale (e.g., 1 to 10), or a binary yes-no option. Possible question and answer combinations could include a poll-style format.

In the event that the facility also utilizes the shopping analysis system, the questions could be specifically targeted to customers. If it is known that a customer visited the bakery during a shopping trip, a specific bakery-focused question could be presented.

Upon the user arriving at the tablet with their shopping equipment, a signal would be sent to the shopping analysis system that the shopping equipment has arrived at a particular tablet and the question on the tablet would be based on that users' specific shopping trip. Once answered, the system would update the answer in the system and or update the user interface on the tablet.

In the event that the store does not utilize the shopping analysis system, the questions and answers that would be displayed on tablets may be per the store owner and store management discretion. The questions can be targeted based on store location and time of day. Store management and ownership would see the answers to questions in a dashboard. The dashboard would be updated based on a schedule or each time an answer is selected by a customer.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications or combinations fall within the art to which this invention relates and are intended to be within the scope of the claims, which follow. It is noted, as is conventional, the use of a singular element in a claim is intended to cover one or more of such an element.

We claim:

1. A system for tracking and quantifying shopping activity comprising:
a plurality of wireless communication devices, wherein said wireless communication devices are each (i) associated with a shopping conveyance and (ii) configured to transmit a data signal that may be received by one or several mobile computing devices;
a database containing an index of wireless communication devices and their associated conveyances;
application software running on the mobile computing devices configured to receive information from said wireless communication devices and store said information in the database.

2. The system of claim 1 wherein the database is used to calculate at least one metric concerning a user's engagement with one of said wireless communication devices.

3. The system of claim 1 wherein said data signal comprises the proximity of one of said wireless communication devices to one or several mobile computing devices.

4. The system of claim 1 wherein said data signal comprises the orientation of one of said wireless communication devices.

5. The system of claim 2 wherein said at least one metric comprises one of duration, dwell time, checkout time, items purchased, and total visit time.

6. The system of claim 1 wherein said application software interacts with said wireless communication devices according to a schedule.

7. The system of claim 6 wherein said schedule is based upon the time of day.

8. The system of claim 6 wherein said schedule is based upon the pattern of the wireless communication devices' prior interactions with said mobile computing devices.

9. The system of claim 1 wherein said application software interacts with said wireless communication devices and facilities the payment for goods in the shopping conveyance.

10. The system of claim 1 wherein said application software is further configured to provide incentives to the user for engagement with the system.

11. A method of tracking and quantifying shopping activity comprising:
receiving, on one or several mobile computing devices, a plurality of signals from a wireless sensor associated with a shopping conveyance, wherein said plurality of signals comprise data concerning a user's engagement with said wireless sensor, a given area of a retail store or with a specific item in the store, and wherein said data is received according to a schedule;
using said data to reference a database of known wireless communication devices and identify the object with which the sensor is associated; and
calculating at least one metric concerning a user's engagement with one of said wireless communication devices.

12. The method of claim 11 wherein said at least one metric comprises one of dwell time, total visit time, and areas of the retail store visited.

13. The method of claim 11, wherein said mobile computing devices store data related to a particular shopping trip.

14. The method of claim 13 wherein said data related to a particular session comprises one of dwell time, total visit time, areas visited, and register attended.

15. The method of claim 11 wherein said schedule is based upon the length of time since the last data was received.

16. The method of claim 11 wherein said schedule is based upon the time of day.

17. The method of claim 11 wherein said schedule is based upon the pattern of prior interactions with said mobile computing devices.

18. The method of claim 11 further comprising the step of providing rewards or incentives to the user for engagement with the system.
